(19) United States
(12) Patent Application Publication
(10) Pub. No.: US 2010/0253497 A1
(43) Pub. Date: Oct. 7, 2010

(54) BRAKE SHOE

(75) Inventors: Sven Bakker, Weinheim (DE); Manfred Reuter, Weilmunster (DE); Henning Thienemann, Berlin (DE)

Correspondence Address: RATNERPRESTIA, P.O. BOX 980, VALLEY FORGE, PA, 19482, US

(73) Assignee: CONTINENTAL TEVES AG & CO. OHG, Frankfurt (DE)

(21) Appl. No.: 12/682,183

(22) PCT Filed: Sep. 23, 2008
(86) PCT No.: PCT/EP08/62686

§ 371 Date: Apr. 8, 2010

(30) Foreign Application Priority Data
Oct. 10, 2007 (DE) 10 2007 048 808.6
Jul. 11, 2008 (DE) 10 2008 032 818.9

(51) Int. Cl. B60Q 1/00

(52) U.S. Cl. 340/454

(57) ABSTRACT

A brake shoe for a brake system has a backplate with a friction lining attached thereto and provisions which are mounted in the region of the friction lining that have the purpose of sensing the wear. In order to sense the state of wear of the friction lining and/or in order to identify the brake shoe, a passive transponder is provided which communicates using a wireless transmission technology, preferably using RFID (radio frequency identification) technology.

### CROSS REFERENCE TO RELATED APPLICATIONS

This application is the U.S. national phase application of PCT International Application No. PCT/EP2008/062686, filed Sep. 23, 2008, which claims priority to German Patent Application No. 10 2007 048 808.6, filed Oct. 10, 2007 and German Patent Application No. 10 2008 032 818.9, filed Jul. 11, 2008, the contents of such applications being incorporated by reference herein.

### FIELD OF THE INVENTION

The invention relates to a brake shoe for a brake system.

### BACKGROUND OF THE INVENTION

DE 40 21 568 A1, which is incorporated by reference, has already disclosed a brake shoe with a friction lining warning device which has, in the region of the friction lining, a plurality of electrical conductor loops which are destroyed and interrupted when there is a certain degree of wear, that is to say starting from a defined residual thickness of the lining. The interrupted conductor loops can be used in various ways to display the wear of the friction lining. For example, the contact points of the conductor loops may be worn away by the brake disk, as a result of which an electrical ground contact is produced with the brake disk in order to close the circuit of the conductor loop.

EP 0754 875 A1, which is incorporated by reference, has already disclosed a brake shoe of the generic type, having a plurality of conductor loops for a wear indicator, which conductor loops are electrically connected to a control unit. The control unit detects an interrupted or, if appropriate, closed circuit if the conductor loops no longer conduct or, if appropriate, if they conduct. The signal derived therefrom is used to draw conclusions about the state of wear of the friction lining and to pass them on, if appropriate, to the driver of the motor vehicle. If a plurality of conductor loops are successively interrupted or become conductive in terms of signaling technology as a result of the progressively worn friction lining, the state of wear of the brake lining can be determined relatively precisely using algorithms which are provided.

### SUMMARY OF THE INVENTION

An object of the invention is to disclose a brake shoe which is improved in terms of the sensing of the state of wear, a brake wear monitoring system for this purpose and a method for operating a brake wear monitoring system, where good technical conditions for the identification of a brake shoe are also to be provided.

According to aspects of the invention, a passive transponder, which permits signals to be processed using a wireless transmission technology, preferably using RFID (Radio Frequency Identification) technology, is provided on the brake lining.

In one advantageous embodiment, the transponder has an RFID microchip which is non-detachably mounted at low cost, particularly in a space-saving fashion, on the backplate of the brake shoe or on the damping plate which is connected to the backplate.

A non-deletable identification code, which is specified for each type of brake shoe is preferably stored on the RFID microchip. This has the advantage that the brake shoes can be unambiguously identified in commerce/shipping/sales situations without a visual method being used. As a result, packed brake shoes can be tracked very easily in logistical terms, and the identification numbers (product number or the like) which has hitherto been printed, bonded or stamped onto the backplate is no longer necessary now.

The use of a passive transponder eliminates the need for a battery to be arranged in the vicinity of the transponder which is secured to the brake shoe since a changing radio frequency field, which is available as an electrical energy source and as a data carrier in order to make the data present in the RFID microchip available to the transceiver unit, can be induced using a transceiver unit arranged on the vehicle bodywork and an antenna coil, preferably a flat coil in the transponder.

The transceiver unit which is arranged on the vehicle bodywork is connected to a control unit in order to activate the transponder and to be able to receive and evaluate the data signals of the transponder, preferably the identification code of the brake shoe and the state thereof. The identification of the brake shoe by means of transponder technology therefore has the advantage that, at any time, the brake shoe which is installed in the vehicle brake system can be precisely identified in an uncomplicated way and also analyzed in terms of the state of wear. The display necessary for this can as a rule be provided for the driver in a clearly recognizable fashion using visual or acoustic means according to requirements or needs.

Further features and advantages of the invention are explained below with reference to the description of a plurality of exemplary embodiments.

### BRIEF DESCRIPTION OF THE DRAWINGS

FIG. 1 shows the rear side of a brake shoe, with a view of a transponder, a coil circuit and a wear pill,

FIG. 2 shows a side view of the brake shoe illustrated in FIG. 1, in conjunction with a transceiver unit which is connected to a control unit and communicates with the transponder using wireless data transmission technology,

FIG. 3 shows a further exemplary embodiment with a view of the rear side of a brake shoe, with a damping plate which is arranged on the backplate and is fitted with a transponder,

FIG. 4 shows the brake shoe according to FIG. 3 in a side view clarifying the two conductor loops which are arranged in a wear pill, and

FIG. 5 shows a further exemplary embodiment of the invention with a view of the friction lining in which a transponder is embedded.

### DETAILED DESCRIPTION OF THE PREFERRED EMBODIMENTS

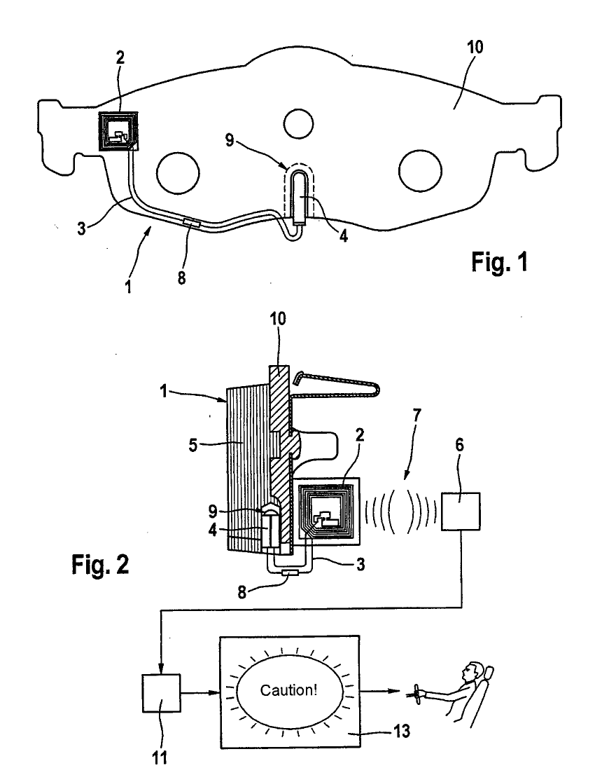

FIG. 1 shows the rear side of a brake shoe 1 with a view of a transponder 2, a coil circuit 3 and a wear pill 9. On the brake shoe 1, the transponder 2 is mounted directly on the backplate 10, the coil circuit 3 of which transponder is connected to a conductor loop 4 which is enclosed in a wear pill 9 which extends in sections into the region of the friction lining 5 which is connected to the backplate 10. In addition, a heat-sensitive securing component 8 is integrated into the coil circuit 3, which securing component 8 is configured in such a way that it is destroyed starting from a certain limiting temperature. When thermal overloading of the brake shoe 1 occurs, the driver can therefore be warned using a suitable acoustic and/or visual display (see display device 13 in FIG. 2), and can be requested to replace the brake shoe set.

FIG. 2 shows a side view of the brake shoe 1 illustrated in FIG. 1, in conjunction with a transceiver unit 6 which is connected to a control unit 11 and communicates with the transponder 2 using wireless data transmission technology, in order to be able to call and evaluate the identification code, the state of wear and/or the state of overloading of the brake shoe 1. More possible details on the display device 13 which is linked to the control unit 11 will not be given at this point.

Starting with the exemplary embodiment according to FIGS. 1 and 2, the basic method of functioning of the invention is such that above a certain degree of wear of the friction lining 5 it is no longer possible for the transponder 2 to be read out by the transceiver unit 6, since the conductor loop 4 of the coil circuit 3 is destroyed by the wear of the friction lining 5. The absent signal 7 of the transponder 2 for determining wear can therefore be used according to the present model, with the difference that the display of wear does not require a cable connection or plug connection between the brake shoe 1 and the peripherals.

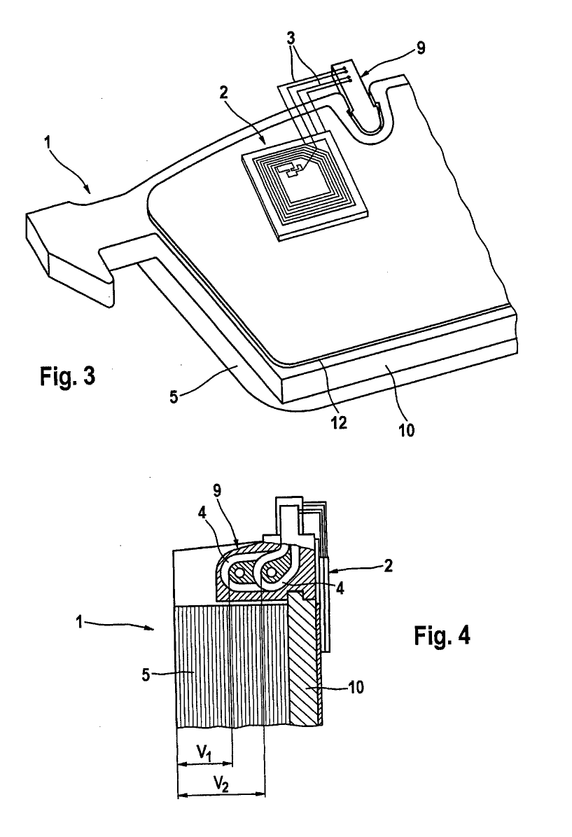

FIG. 3 shows a further exemplary embodiment of the invention with a view of the rear side of a brake shoe 1, which is fitted on the backplate 10 with a damping plate 12 on which a transponder 2 is secured. The arrangement of the transponder 2 on the damping plate 12 is advantageous for minimizing the thermal loading on the transponder 2, wherein, in principle, further special insulating means may be arranged between the transponder 2 and the brake shoe 1 when required or needed, in order to keep the temperature effect on the transponder 2 low.

FIG. 4 shows the brake shoe 1 according to FIG. 3 in a side view clarifying the two conductor loops 4 which are arranged in a wear pill, and are arranged in a row in the wear pill 9. Owing the to the row arrangement, the conductor loops 4 are successively interrupted as the wear V₁,V₂ progresses, as a result of which the signal of the transponder 2 changes in such a way that more precise determination of the wear of the friction lining becomes possible. The arrangement of two transponders 2 which are advantageously integrated with one another on the brake shoe 1 with the result that each conductor loop 4 is separately connected to one of the two transponders 2, is preferably suitable for this.

Although it is not explicitly stated in the previous exemplary embodiments, the backplate 10 preferably has a recess or a projection in order to ensure favorable securing for the purpose of better application of the transponder 2, in particular by using the bonding technology. Alternatively, the transponder 2 can be attached, together with the damping plate 12, to the backplate 10 using suitable shaping means, preferably by riveting.

In addition, a moisture-sensitive additional component can also be provided on the RFID microchip of the transponder 2, which additional component interrupts/changes the signal or a component signal of the microchip, with the result that the influence of moisture which reduces the braking power can be reliably sensed and, if appropriate, reduced by suitable supplementary braking functions (for example by a brief application of the brake shoes to the brake disk in order to wipe away the water film).

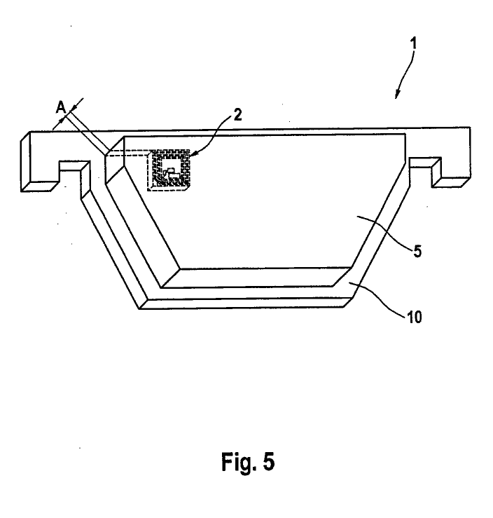

Finally, FIG. 5 is intended to explain a further exemplary embodiment of the invention with a view of the friction lining 5 in which the transponder 2 is embedded directly. The transponder 2 which is embedded in the friction material and pressed with the friction lining 5 does not require any cables or contacts to be routed using conductor loops and wear pills but rather is simply destroyed when the wear of the friction lining increases. The transponder 2 is therefore embedded in the friction lining 5 spaced apart from the backplate 10, at a distance A from the minimum permissible friction lining thickness, with the result that when the minimum friction lining thickness is reached, the transponder 2 is worn and its signal is lost, and therefore the control unit 11 senses the worn-away friction lining 5. When desired or necessary, it is possible, for the purpose of sensing different friction lining thicknesses, for a plurality of transponders 2 to be embedded at different depths of the friction lining 5, which depths are destroyed successively, enabling the state of wear to be displayed successively by means of the control unit 11.

The precise positioning of the transponder 2 at a distance A from the backplate 10 is preferably achieved by virtue of the fact that the transponder 2 comprises a spacer element which has a thickness in the region of the minimum friction lining thickness.

In order to keep the shielding effect of the friction lining 5, which is disruptive for the transmission of signals between the transponder 2 and the transceiver unit 6, as low as possible, the transponder 2 is arranged in an edge region of the friction lining 5. The transponder 2 can also be provided with a hole or the like with the result that the lining mass engages through the transponder 2, as a result of which the coherence of the friction lining 5 is adversely affected only to an insignificant degree.

Basically, in all the embodiments of the invention which are shown in FIGS. 1-5, data exchange with the transponder 2 is carried out by means of the transceiver unit 6 at defined time intervals, which transponder 2 comprises a type-specific and/or wear-specific identification code for the brake shoe 1, with the result that transponder data which are received by the transceiver unit 6 are reconciled, by means of an evaluation circuit, with setpoint data which are stored in the control unit 11, where an optical and/or acoustic warning signal can be initiated using a display device 13 either when the received transponder data deviate from the setpoint data or when the data exchange fails.

When desired or required it is also possible to produce a wear model for the brake shoe 1 as a function of the degree of wear of the transponder 2 and/or of a plurality of conductor loops 4 which are connected to the transponder 2, in order to form wear predictions in the control unit 11.

The transmission of signals between the transceiver unit 6 and the transponder 2 includes in all cases an identification code which provides conclusive information about the brake shoe 1 installed in the brake system, and the state of said brake shoe 1. If a plurality of conductor loops 4 are connected to one or more transponders 2, or alternatively a plurality of transponders 2 are embedded at various depths in the friction lining 5 in such a way that they can be eliminated through erosion of the friction lining, the further wear of each brake shoe 1 can be predicted very precisely by means of the control unit 11.

Whenever a brake shoe set is replaced, calibration then takes place once more in the control unit 11 on the basis of the identification code of the new brake shoes 1. This individual calibration process contributes to ensuring no interference with other brake wear monitoring systems of the same design occurs in road traffic.

1-15. (canceled)

16. A brake shoe for a brake system comprising:
a backplate with a friction lining attached thereto;
a means for sensing the state of wear of the friction lining, wherein the sensing means is mounted in the region of the friction lining; and
a passive transponder, equipped with a wireless signal transmission technology and configured to communicate the state of wear of the friction lining and/or the identity of the brake shoe.

17. The brake shoe as claimed in claim 16, wherein the transponder has a microchip on which wear-specific and/or lining-specific parameters for the friction lining are stored.

18. The brake shoe as claimed in claim 17, wherein the wear-specific and/or lining-specific parameters for the friction lining are stored in the microchip using suitable coding.

19. The brake shoe as claimed in claim 16, wherein the transponder is non-detachably secured either to the backplate or to a damping plate which is connectable to the backplate.

20. The brake shoe as claimed in claim 19, wherein the transponder is attached to the backplate together with the damping plate using a rivet connection.

21. The brake shoe as claimed in claim 16, wherein a coil circuit, which connects the transponder to a wear pill which extends at least partially into the brake lining, is secured either to the backplate or to a damping plate which can be connected to the backplate.

22. The brake shoe as claimed in claim 21 wherein a heat-sensitive securing component is integrated into the coil circuit.

23. The brake shoe as claimed in claim 16, wherein the sensing means has at least one electric conductor loop which is connected to the transponder.

24. The brake shoe as claimed in claim 23, wherein in order to sense the wear of a brake lining using a transponder signal which is characteristic for the friction wear, two conductor loops, which can be successively disconnected as the wear of the friction lining progresses, are integrated at least into a wear pill.

25. The brake shoe as claimed in claim 16, wherein the backplate has a recess or a projection for accommodating the transponder in a materially joined fashion.

26. The brake shoe as claimed in claim 16, wherein the transponder is embedded in the friction lining at a defined depth distance (A) with respect to the backplate.

27. The brake shoe as claimed in claim 16, wherein in order to sense moisture on the friction lining, the transponder is provided with a moisture-sensitive additional component which generates a transponder signal which is representative of a degree of moisture of the friction lining.

28. A brake wear monitoring system having a brake shoe for a brake system as claimed in claim 16 wherein a transceiver unit which is remote from the brake shoe and communicates by wireless data transmission technology with the passive transponder which is secured to the brake shoe.

29. The brake wear monitoring system as claimed in claim 28, wherein in order to evaluate transponder signals and to communicate with a display device, the transceiver unit is linked to a control device which contains control functions for a brake slip controller provided for the brake system.

30. A method for operating a brake wear monitoring system as claimed in claim 28,
wherein data exchange with the transponder is carried out by the transceiver unit at defined time intervals,
wherein the transponder comprises a type-specific and/or wear-specific identification code for the brake shoe,
wherein the transponder data which are received by the transceiver unit are reconciled, by an evaluation circuit, with setpoint data which are stored in the control unit, where an optical and/or acoustic warning signal is initiated using a display device either when received transponder data deviate from the setpoint data or when a data exchange fails.

31. The method for operating a brake wear monitoring system as claimed in claim 30, wherein a wear model for the brake shoe is produced as a function of a degree of the wear of the transponder and/or of a plurality of conductor loops which are connected to the transponder, in order to form wear predictions in the control unit.

32. The brake shoe as claimed in claim 16, wherein the wireless signal transmission technology is Radio Frequency Identification (RFID) technology.
